(19) United States
(12) Patent Application Publication
(10) Pub. No.: US 2026/0017380 A1
(43) Pub. Date: Jan. 15, 2026

(54) Enhanced Real-Time Supply Chain Analysis

(71) Applicant: MICRO FOCUS LLC, WILMINGTON, DE (US)

(72) Inventors: DOUGLAS MAX GROVER, RIGBY, ID (US); MICHAEL F. ANGELO, HOUSTON, TX (US)

(73) Assignee: MICRO FOCUS LLC, WILMINGTON, DE (US)

(21) Appl. No.: 18/768,981

(22) Filed: Jul. 10, 2024

(51) Int. Cl. G06F 21/57; G06F 8/33; G06F 8/61

(52) U.S. Cl. CPC G06F 21/577; G06F 8/33; G06F 8/61; G06F 2221/033

(57) ABSTRACT

A determination is made, in real-time, that a software application is one of: running, being loaded, being installed, or has been installed. In response to determining, in real-time, that the software application is one of: running, being loaded, being installed, or has been installed, one or more software components that are associated with the software application are identified. For example, a software component may be a library that is dynamically loaded by the software application. Current supply chain data is generated. The current supply chain data is associated with the software application and the identified one or more software components associated with the software application. The current supply chain data is processed to identify one or more vulnerabilities in the software application and/or the identified one or more software components associated with the software application.

### FIELD

The disclosure relates generally to analyzing supply chains for software applications and/or Artificial Intelligence (AI) algorithms and particularly to analyzing supply chains for software applications and/or AI algorithms in real-time.

### BACKGROUND

Accurate supply chain data (a.k.a. a Software Bill-of-Materials (SBOM)) is critical to identifying vulnerabilities in software. For example, a vulnerability may be a new type of malware in the software application. Currently, supply chain data is limited to review when a software application and/or AI algorithm are initially created and tested. While this is valuable, many times, vulnerabilities may be identified after the software application and/or AI algorithm have been released and are running on a system. This can lead to security issues in the software application and/or the AI algorithm.

### SUMMARY

These and other needs are addressed by the various embodiments and configurations of the present disclosure. The present disclosure can provide a number of advantages depending on the particular configuration. These and other advantages will be apparent from the disclosure contained herein.

A determination is made, in real-time, that a software application is one of: running, being loaded, being installed, or has been installed. In response to determining, in real-time, that the software application is one of: running, being loaded, being installed, or has been installed, one or more software components that are associated with the software application are identified. For example, a software component may be a library that is dynamically loaded by the software application while it is running. Current supply chain data is generated. The current supply chain data is associated with the software application and the identified one or more software components associated with the software application. The current supply chain data is processed to identify one or more vulnerabilities in the software application and/or the identified one or more software components associated with the software application. For example, the current supply chain data may identify a buffer overflow vulnerability in one of the software components.

The phrases “at least one”, “one or more”, “or,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine,” “calculate” and “compute,” and variations thereof, as used herein, are used interchangeably, and include any type of methodology, process, mathematical operation, or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The term “blockchain” as described herein and in the claims refers to a growing list of records, called blocks, which are linked using cryptography. The blockchain is commonly a decentralized, distributed and public digital ledger that is used to record transactions across many computers so that the record cannot be altered retroactively without the alteration of all subsequent blocks and the consensus of the network. Each block contains a cryptographic hash of the previous block, a timestamp, and transaction data (generally represented as a merkle tree root hash). For use as a distributed ledger, a blockchain is typically managed by a peer-to-peer network collectively adhering to a protocol for inter-node communication and validating new blocks. Once recorded, the data in any given block cannot be altered retroactively without alteration of all subsequent blocks, which requires consensus of the network majority. In verifying or validating a block in the blockchain, a hashcash algorithm generally requires the following parameters: a service string, a nonce, and a counter. The service string can be encoded in the block header data structure, and include a version field, the hash of the previous block, the root hash of the merkle tree of all transactions (or information or data) in the block, the current time, and the difficulty level. The nonce can be stored in an extraNonce field, which is stored as the left most leaf node in the merkle tree. The counter parameter is often small at 32-bits so each time it wraps the extraNonce field must be incremented (or otherwise changed) to avoid repeating work. When validating or verifying a block, the hashcash algorithm repeatedly hashes the block header while incrementing the counter & extraNonce fields. Incrementing the extraNonce field entails recomputing the merkle tree, as the transaction or other information is the left most leaf node. The body of the block contains the transactions or other information. These are hashed only indirectly through the Merkle root.

As defined herein, the term “software” may include firmware. In addition, the term “software component” may be any software/firmware that is associated with a software application/AI algorithm.

As defined herein, the term “vulnerability” may include various kinds of issues associated with software/firmware, such as malware, viruses, bugs, security issues, execution issues, memory issues, memory leaks, authentication issues, low encryption levels, performance issues, and/or the like. A vulnerability may include a potential vulnerability. For example, a potential vulnerability may include source code that is developed in a country that notoriously generates malware or a developer that previously introduced a vulnerability/malware into a software component.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 is a block diagram of a first illustrative system for enhanced real-time supply chain analysis.

FIG. 2 is a block diagram of a second illustrative system for enhanced real-time supply chain analysis of software applications.

FIG. 3 is a block diagram of a third illustrative system for enhanced real-time supply chain analysis of AI algorithms.

FIG. 4 is a flow diagram of a process for enhanced real-time supply chain analysis.

FIG. 5 is a flow diagram of a process for gathering current supply chain data.

FIG. 6 is a diagram of a user interface for providing enhanced real-time supply chain analysis.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

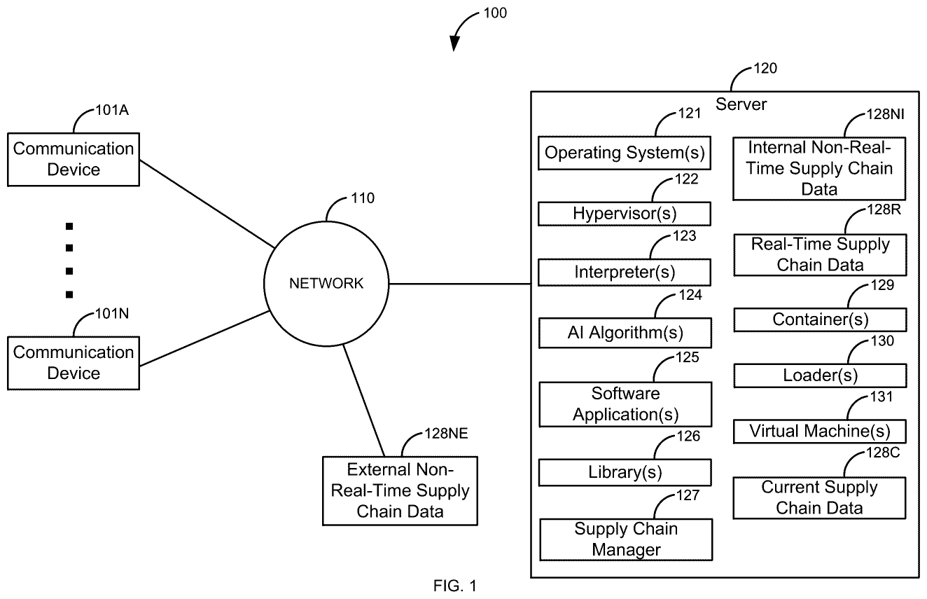

FIG. 1 is a block diagram of a first illustrative system 100 for enhanced real-time supply chain analysis. The first illustrative system 100 comprises communication devices 101A-101N, a network 110, a server 120, and external non-real-time supply chain data 128NE.

The communication devices 101A-101N can be or may include any user device that can be used to access the server 120, such as a Personal Computer (PC), a cellular telephone, a Personal Digital Assistant (PDA), a tablet device, a notebook device, a smartphone, a laptop computer, and/or the like. As shown in FIG. 1, any number of communication devices 101A-101N may be connected to the network 110, including only a single communication device 101

The network 110 can be or may include any collection of communication equipment that can send and receive electronic communications, such as the Internet, a Wide Area Network (WAN), a Local Area Network (LAN), a packet switched network, a circuit switched network, a cellular network, a combination of these, and the like. The network 110 can use a variety of electronic protocols, such as Ethernet, Internet Protocol (IP), Hyper Text Transfer Protocol (HTTP), Web Real-Time Protocol (Web RTC), and/or the like. Thus, the network 110 is an electronic communication network configured to carry messages via packets and/or circuit switched communications.

The server 120 may be any type of server 120 that is used to host the software application(s) 125 and/or the AI algorithm(s) 124. Users access the software application(s) 125 and/or the AI algorithm(s) 124 via the communication devices 101A-101N.

The server 120 further comprises an operating system(s) 121, hypervisor(s) 122, interpreter(s) 123, AI algorithm(s) 124, software application(s) 125, library(s) 126, a supply chain manager 127, internal non-real-time supply chain data 128NI, real-time supply chain data 128R, container(s) 129, loader(s) 130, and virtual machine(s) 131.

The operating system(s) 121 may be any type of operating system 121, such as Linux®, Microsoft Windows®, iOS®, ChromeOS®, Android®, and/or the like. The operating system(s) 121 are used to manage the software application(s) 125/AI algorithms 124.

The hypervisor(s) 122 are used to load the containers 129/virtual machines 131. The hypervisor(s) 122 may be a type 1 hypervisor (bare metal), a type 2 hypervisor (hosted), and/or the like.

The interpreter(s) 123 are a software application that is used to interpret source code to run an application 125. For example, the interpreter 123 may be a Java Virtual Machine (JVM).

The AI algorithm(s) 124 may be any type of AI algorithm 124, such as, a supervised machine learning algorithm, an unsupervised machine learning algorithm, a semi-supervised machine learning algorithm, a neural network, a generative AI algorithm, and/or the like.

The software application(s) 125 may be any type of software application 125, such as a web application, a security application, a network management application, a database application, a user application, a cloud service, a financial application, an AI algorithm 124, a computer application, and/or the like. The Software application(s) 125 may be binaries, interpreted software applications 125, and/or the like. The software application 125 may include firmware.

The library(s) 126 may be any type of library 126 used by the software application(s) 125/AI algorithm(s) 124, such as dynamic linked library (DLL), a static library, a dynamic library, a class library, and/or the like.

The supply chain manager 127 can be or may include any hardware coupled with software that can be used to manage the supply chain data 128 (e.g., 128NE, 128NI, and/or 129R). The supply chain manager 127 monitors the AI algorithm(s) 124 and/or the software application(s) 125 and their associated software components to identify vulnerabilities in the supply chain for the software application(s) 125 and/or AI algorithm(s) 124. The supply chain manager 127 can monitor the supply chain data 128 in real-time as the software components are loaded/executed. For example, each time a library 126 is loaded, version information and the associated supply chain data 128 may be captured. If the library version changes the next time the library 126 is loaded, the supply chain manger 127 can capture the new version information/supply chain data 128. Thus the supply chain manager 127 builds the current supply chain data 128C in real-time.

The internal non-real-time supply chain data 128NI is non-real-time supply chain data 128N that is captured in non-real-time and is stored on the server 120. Examples of non-real-time supply chain data 128N (either internal or external non-real-time supply chain data 128N) may be non-real-time supply chain data 128N that is captured in a development environment while the software application 125 is being developed, tested, shipped, and/or the like. The internal non-real-time supply chain data 128NI may come from a Software Bill-of-Materials (SBOM) for the software application 125 and/or the AI algorithm 124. For example, the non-real-time supply chain data 128NI may include supply chain data 128N of a compiler (a software component) used to generate the software application 125.

The real-time supply chain data 128R is supply chain data 128 that is captured in real-time while the software application 125 is running. For example, the real-time supply chain 128R data may be captured by monitoring input prompts that are provided to the AI algorithm 124, supply chain data 128 that is captured when the input prompts are filtered in real-time, supply chain data 128 captured when an executed application 125E is executed from the software application 125, supply chain 128 data when a library 126 is changed and then loaded, supply chain data 128 when an output application 1250 is changed or added, and/or the like.

The container 129 may be used to host/manage the software application(s) 125/AI algorithm(s) 124. The container 129 is typically loaded by the hypervisor 122.

The loader 130 is used to load a software application 125. The loader 130 may include a linker (i.e., a loader/linker).

The virtual machine 131 may be used to host the software application(s) 125/AI algorithm(s) 124. The virtual machine 131 may include a separate operating system 121 for each virtual machine 131.

The current supply chain data 128C is supply chain data 128 that is currently associated with the software application 125 in the software application's runtime environment (e.g., where it is running, being loaded, installed, has been installed, etc.). For example, if the software application 125 is being loaded and was developed with a specific Integrated Development Environment (IDE), was created using a specific compiler, loads a specific library 126, executes another software application 125, is loaded with a specific loader 130, the current supply chain data 128C will reflect the supply chain data 128 (either real-time supply chain data 128R and/or non-real-time supply chain data 128N) of each of the associated software components along with the supply chain data 128 (either real-time and/or non-real-time) of the software application 125.

The external non-real-time supply chain data 128NE is non-real-time supply chain data 128NE that is stored external to the server 120. For example, the external non-real-time supply chain data 128NE may be non-real-time external supply chain data 128NE that is stored in an open-source repository (e.g., GitHub) that has non-real-time supply chain data 128N of a specific open-source component that is used to develop the software application 125.

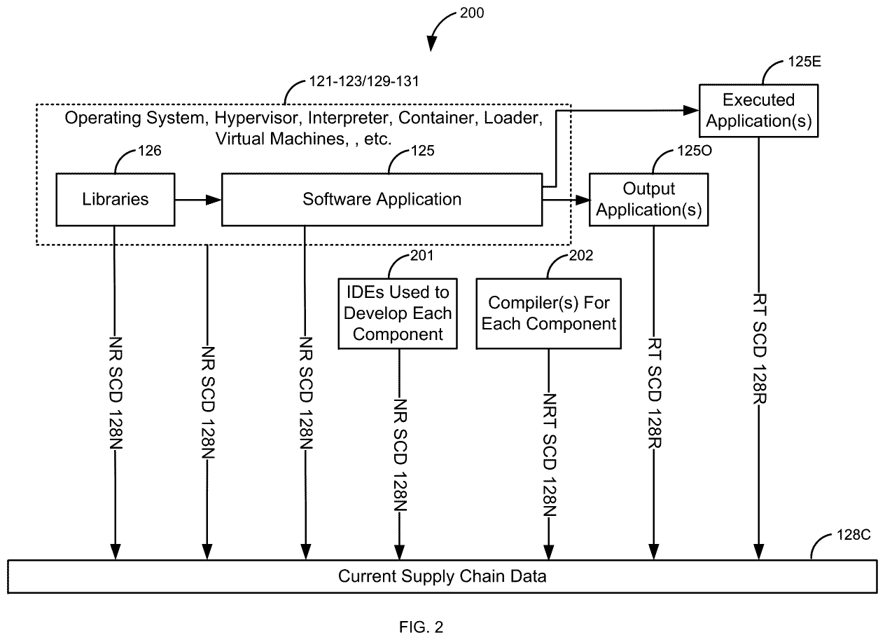

FIG. 2 is a block diagram of a second illustrative system 200 for enhanced real-time supply chain analysis of software applications 125. The second illustrative system 200 comprises the operating system(s) 121, hypervisor(s) 122, interpreter(s) 123, the container(s) 129, the loader(s) 130, the virtual machine(s) 131, the software application(s) 125, the library(s) 126, the output application(s) 1250, the executed application(s) 125E, Integrated Development Environment(s) (IDEs) used to develop each software component 201, compiler(s) 202 for each software component 202, and the current supply chain data 128C.

When the software application 125 is installed, is being installed, has been installed, loaded, and/or running the supply chain manager 127 gathers supply chain data 128 for the software component(s) that are related to the software application 125 to produce current supply chain data 128C. The current supply chain data 128C may include Real-Time Supply Chain Data (RT SCD) 128R and/or Non-Real Time Supply Chain Data (NRT SCD 128NI and/or 128NE).

As shown in FIG. 2, the supply chain manager 127 gathers non-real-time supply chain data 128N about the operating system 121, the hypervisor 122, the container 129, the loader 130, the virtual machine 131, the libraries 126, the software application 125, the IDEs 201 used to develop each software component, the compilers 202 used for each software component (depending on which ones are used), any output application(s) 1250 and/or executed application(s) 125E. For example, if when the software application 125 is running, and the following software components are used: an operating system 121, a loader 130, and an executed application 125E are used, the following supply chain data 128 may be used to create the current supply chain data 128C: non-real-time supply chain data 128N for the software application 125, non-real-time supply chain data 128N for the operating system 121, non-real-time supply chain data 128N for the loader 130, non-real-time supply chain data 128N for an IDE 201 that is used to develop the operating system 121, non-real-time supply chain data 128N for the IDE 201 is used to develop the software application 125, non-real-time supply chain data 128N for the IDE 201 used to develop the compiler 202, non-real-time supply chain data 128N for the IDE 201 used to develop the loader 130 etc., real-time supply chain data 128R for the executed application 125E that is executed by the software application 125 while running, would comprise current supply chain data 128C for the software application 125.

Although not shown, other software components may be part of the current supply chain data 128C. For example, an installer of the software application 125 may be part of the non-real-time supply chain data 128N that is in the current supply chain data 128C.

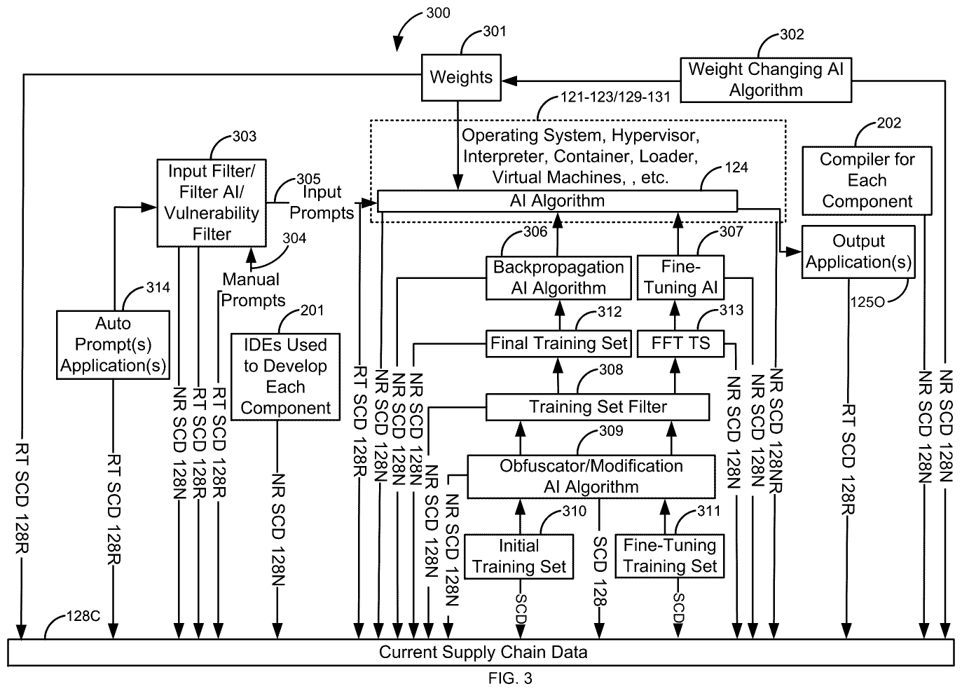

FIG. 3 is a block diagram of a third illustrative system 300 for enhanced real-time supply chain analysis of AI algorithms 124. The third illustrative system 300 comprises the operating system(s) 121, the hypervisor(s) 122, the interpreter(s) 123, the container(s) 129, the loader(s) 130, the virtual machine(s) 131, the AI algorithm 124, the output application(s) 1250, the Integrated Development Environment(s) (IDEs) used to develop each software component 201, the compiler(s) 202 for each software component 202, weights 301, a weight changing AI algorithm 302, input filter/filter AI/vulnerability filter 303, manual prompts 304, input prompts 305, a backpropagation AI algorithm 306, a fine-tuning AI algorithm 307, a training set filter 308, an obfuscator/modification AI algorithm 309, an initial training set 310, a fine-tuning training set 311, a final training set 312, a final fine-tuning training set 313, and the current supply chain data 128C.

In FIG. 3, the supply chain analysis is specific to the AI algorithm 124. For example, non-real-time supply chain data 128N for the AI algorithm 124, such as version number, software components used to create the AI algorithm 124, source of the software components used to create the AI algorithm 124, repositories that software components came from, country of origin of the software components, writers of the software components (how likely are they to write code with defects, has the author inserted malware into code, etc.), vulnerabilities/defects, and/or the like are identified for the AI algorithm 124. The non-real-time supply chain data 128N may include patents associated with AI algorithm 124, software licenses associated with the software components, and/or any intellectual property associated with any source code associated with the AI algorithm 124.

Like discussed in FIG. 2, non-real-time supply chain data 128N can be gathered for the operating system 121, the hypervisor 122, the interpreter 123, the container 129, the loader 130, the virtual machine 131, the compiler(s) 202, the IDEs 201 used for each software component, and the output applications 1250 to build the current supply chain data 128C.

In addition, non-real-time supply chain data 128N can be gathered for the weight changing AI algorithm 302. The weight changing algorithm 302 is trained to create new versions/functionality of the AI algorithm 124 by changing the weights 301 of the AI algorithm 124. If the weights 301 of the AI algorithm 124 are changed by the weight changing AI algorithm 302, the non-real-time supply chain data 128N may also include the non-real-time supply chain data 128N of the weight changing AI algorithm 302 along with the weights 301 that were changed, added, and/or deleted by the weight changing AI algorithm 302. If the weight changing AI algorithm 302 is used, there may not be an associated final training set 312.

In FIG. 3 the supply chain analysis may apply to the training set used to train the AI algorithm 124. As shown in FIG. 3, there may be an initial training set 310. The initial training set 310 may be run through an obfuscator/modification AI algorithm 309 that changes the source code/data of the initial training set 310. In addition, a training set filter 308 may be used (e.g., to manually and/or automatically filter out training set data 128) to produce a final training set 312. The final training set 312 is used by the backpropagation AI algorithm 306 to train the AI algorithm 124. Each of these software components can be used to generate non-real-time supply chain data 128N for the current supply chain data 128C.

Likewise, if the AI algorithm 124 is fine-tuned, the software components used to fine-tune the AI algorithm 124 can be used to build the current supply chain data 128C. The non-real-time supply chain data 128N for the fine-tuning training set 311, the obfuscator/modification AI algorithm 309, the training set filter 308, the Final Fine-Tuning Training Set (FFT TS) 313, and the fine-tuning AI algorithm 307 can be used to generate non-real-time supply chain data 128N for the current supply chain data 128C.

For example, if the AI algorithm 124 is initially trained using version 1.1 of the backpropagation algorithm 306 and the fine-tuning AI algorithm 307 is version 3.4, all the non-real-time supply chain data 128N for the versions of the of backpropagation AI algorithm 306/fine-tuning AI algorithm 307 can be stored and tracked as part of the current supply chain data 128C for the AI algorithm 124.

The current supply chain analysis could apply to source code or non-source code used to train and/or fine-tune the AI algorithm 124. For example, if an image is used to train the AI algorithm 124, where the image came from, who authored the image, the date the image was created, country of origin of the image, and/or the like can be captured and stored off. Similar tracking can be done for documents, websites (e.g., information scraped from websites).

Likewise, with training source code, the supply chain data of each software component used to train the AI algorithm 124 may include version information, who wrote the source code, known defects/vulnerabilities, copyright information, license information, origin of the source code (e.g., from a malicious country), origin of each user who modified the source code, quality of the source code/user (e.g., has the user inserted malware into the source code previously), where the source code came from (e.g., GitHub), and/or the like.

In addition to the non-real-time supply chain data 128N, real-time supply chain data 128R can also be gathered. Real-time supply chain data 128R can be gathered when the weights 301 of the AI algorithm 124 are changed while the AI algorithm 124 is running or changed in the execution environment. Real-time supply chain data 128R can be captured in the output of the AI algorithm 124, based on which output application(s) 1250 the output of the AI algorithm 124 is sent to or based on the actual output data.

Real-time supply chain data 128R can be captured from the input prompts 305 to the AI algorithm 124. Input prompts 305 may be captured based on adding a hook to the source code/binary of the AI algorithm 124. This may include automatically generated input prompts 305, manual prompts 304, filtered input prompts, and/or the like. In addition, if the input filter/AI vulnerability filter 303 is used to filter the input prompts 305, what prompts were filtered can be used as part of the real-time supply chain data 128R. The various kinds of real-time supply chain data 128R can be used to build the current supply chain data 128C in real-time. For example, for a manual prompt 304, the real-time supply chain data 128R may include the user who provided the manual prompt 304, the time the manual prompt was entered, the country the user is from, the actual manual prompt 303, and/or the like.

The value to capturing input prompts 305 in real-time is because generative AI algorithms 124 can learn based on input prompts 305. Some generative AI algorithms 124 can be compromised based on a series of malicious input prompts 305 to bias the AI algorithm 124 in unwanted ways. Thus, it may be important to track the input prompts 305 in real-time to identify a potential attack of the AI algorithm 124 and a potential attack of the supply chain.

The current supply chain data 128C may be stored in a blockchain. For example, the supply chain data 128 for each software component (any of those described above) may be stored in individual blocks of a blockchain. Likewise, a supply chain for the software component(s) used to generate the input prompts 305 may be stored in a blockchain along with the supply chain data 128 of the weight changing AI algorithm 302/weights 301. As the supply chain data changes (e.g., each time the AI algorithm 124 is loaded or when new input prompts 305 are provided to the AI algorithm 124), this data can be tracked and stored in the blockchain. The structure of the blockchain may be forked based (or star based) based on retraining/new version of the AI algorithm 124.

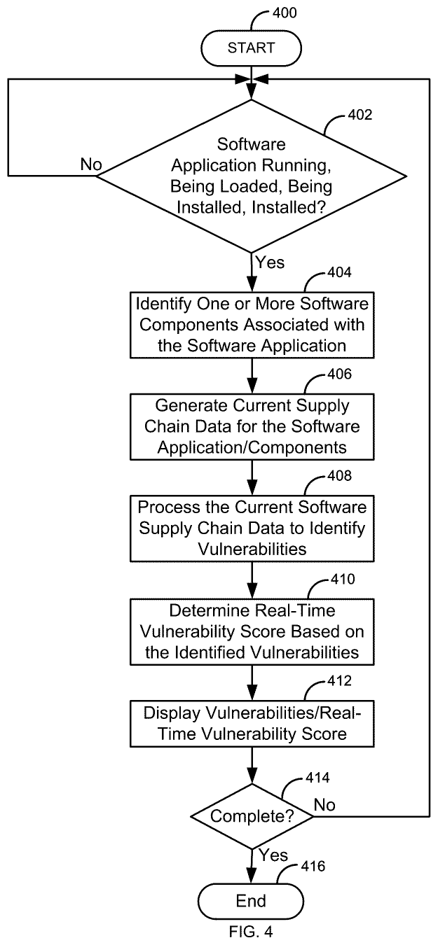

FIG. 4 is a flow diagram of a process for enhanced real-time supply chain analysis. Illustratively, the communication devices 101A-101N, the server 120, the operating system(s) 121, the hypervisor(s) 122, the interpreter(s) 123, the AI algorithm(s) 124, the software application(s) 125, the library(s) 126, the supply chain manager 127, the container(s) 129, the loader(s) 130, the virtual machine(s) 131, the executed application(s) 125E, the output application(s) 1250, the IDE(s) 201, the compiler(s) 202, the weight changing AI algorithm 302, the input filter/filter AI/vulnerability filter 303, the backpropagation AI algorithm 306, the fine-tuning AI algorithm 307, the training set filter 308, and the obfuscator/modification AI algorithm 309 are stored-program-controlled entities, such as a computer or microprocessor, which performs the methods of FIGS. 4-6 and the processes described herein by executing program instructions stored in a computer readable storage medium, such as a memory (i.e., a computer memory, a hard disk, and/or the like). Although the methods described in FIGS. 4-6 are shown in a specific order, one of skill in the art would recognize that the steps in FIGS. 4-6 may be implemented in different orders and/or be implemented in a multi-threaded environment. Moreover, various steps may be omitted or added based on implementation.

The process starts in step 400. The supply chain manager 127 determines, in step 402, if the software application 125 (e.g., an AI algorithm 124) is running, being loaded, being installed, or installed. For example, the software application 125 may have been developed and has been installed at a customer site. If the software application 125 is not running, being loaded, installed, or being installed in step 402, the process of step 402 repeats.

Otherwise, if the software application 125 is running, has been loaded, is being installed, or has been installed in step 402, the supply chain manager 127 identifies one or more software components associated with the software application 125 in step 404. For example, a manifest of the supply chain data 128 associated with the software application 125 may be provided in the internal non-real-time supply chain data 128NI and/or external non-real-time supply chain data 128NE. Another way that the software components may be identified may be by the loader 130. For example, the loader 130 may identify links of libraries 126 that are loaded and used by the software application 125.

The supply chain manager 127 generates the current supply chain data 128C for the software application 125/software components 121-123/126/129-131/201-202/301-314, etc. in step 406. The supply chain manager 127 generates the current supply chain data 128C based on the non-real-time supply chain data 128N and the real-time supply chain data 128R like described above. The supply chain manager 127 processes, in step 408, the current supply chain data 128C to identify any vulnerabilities. For example, the supply chain manager 127 may identify, in step 408, different types of malware and/or malicious input prompts 305 in the current supply chain data 128C.

The supply chain manager 127 determines, in step 410, a real-time vulnerability score based on the identified vulnerabilities. The real-time vulnerability score may be based on the size of the software application 125, the severity of the vulnerabilities, and/or the like. The real-time vulnerability score may be based on a range (e.g., 1 to 10 where 10 is the highest vulnerability). The supply chain manager 127 may then display, in step 412, the vulnerabilities/real-time vulnerability score in a user interface.

The supply chain manager 127 determines, in step 414, if the process is complete. If the process is not complete in step 414, the process goes back to step 402 to look for changes in the current supply chain data 128C. For example, the supply chain manager 127 may detect new input prompts 305, a library 126 being loaded, an executed application 125E being executed by the software application 125, weights 301 being changed in real-time, and/or the like. Otherwise, if the process is complete in step 414, the process ends in step 416.

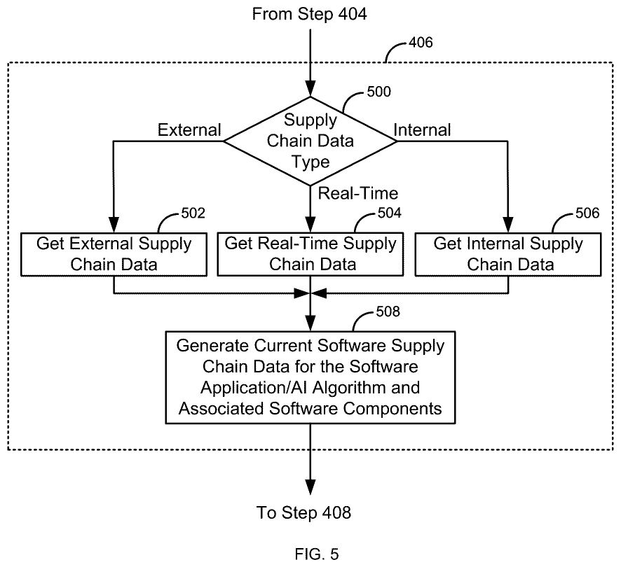

FIG. 5 is a flow diagram of a process for gathering current supply chain data 128C. FIG. 5 is an exemplary embodiment of step 406 of FIG. 4. After identifying the one or more software components associated with the software application 125 in step 404, the supply chain manager 127 captures at the supply chain data 128 associated with each software component. The supply chain manager 127 also looks at where the supply chain data 128 is located (e.g., externally to the server 120 or internally on the server 120) or a source of the supply chain data 128 (e.g., a source of where the real-time supply chain data 128R comes from) in step 500. Step 500 may be executed in parallel. For example, if there is external non-real-time supply chain data 128NE, internal non-real-time supply chain data 128NI, and real-time supply chain data 128R, each of the steps 502, 504, and 506 may be executed in parallel (or could be done serially).

If the non-real-time supply chain data 128NE is located externally, the supply chain manager 127 gets the non-real-time supply chain data 128NE for the software application 125/software components, in step 502, and the process goes to step 508. If the non-real-time supply chain data 128NI is located internally, the supply chain manager 127 gets the non-real-time supply chain data 128NI for the software application 125/software components, in step 504, and the process goes to step 508. If there is real-time supply chain data 128R the supply chain manager 127 gets the real-time supply chain data 128R for the software application 125/software components (those that have real-time supply chain data 124R) in step 506 and the process goes to step 508.

The supply chain manager 127 generates the current supply chain data 128C for the software application 125/associated software components based on the supply chain data 128 gathered in step 502, 504, and 506. The process then goes to step 408.

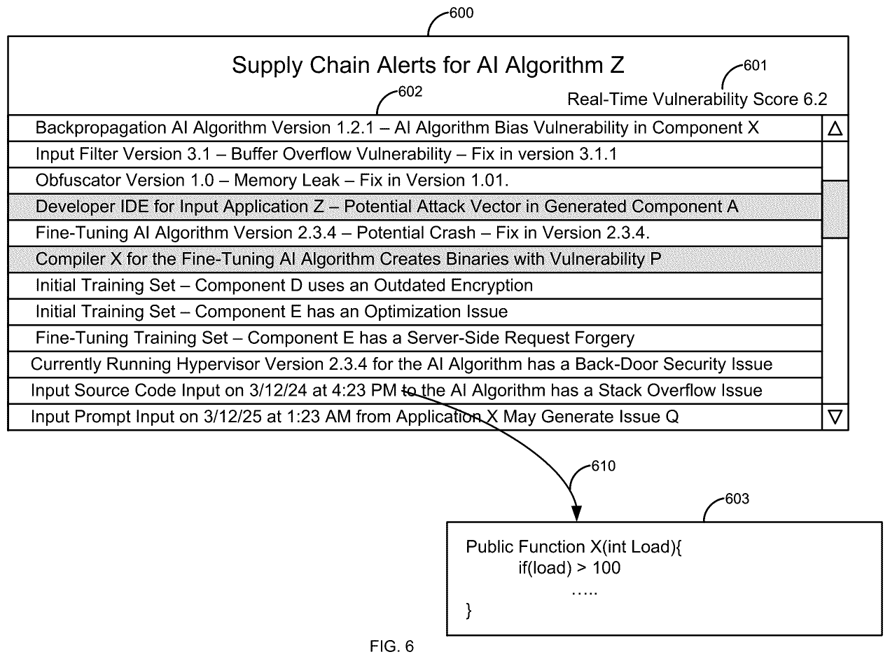

FIG. 6 is a diagram of a user interface 600 for providing enhanced real-time supply chain analysis. Based on the current supply chain data 128C, the user can be provided with alerts and can monitor the software application 125 supply chain and its associated software components in real time via the user interface 600. FIG. 6 shows an example of how this may be accomplished using the AI algorithm 124 as an exemplary software application 125.

The user interface 600 comprises a real-time vulnerability score 601 and a list of vulnerabilities 602. The real-time vulnerability score 601 is calculated based on the vulnerabilities in the list of vulnerabilities 602. The list of vulnerabilities 602 comprises twelve vulnerabilities that are currently being shown to the user. Although not shown, there may be other vulnerabilities in the list of vulnerabilities that the user may scroll to. The list of vulnerabilities 602 has two vulnerabilities that are highlighted as being more sever vulnerabilities: 1) “Developer IDE for Input Application Z-Potential Attack Vector in Generated Component A”, and 2) “Compiler X for the Fine-Tuning AI Algorithm Creates Binaries with Vulnerability P.”

If the user wants more detail on a particular vulnerability, the user can click on a particular item in the list of vulnerabilities 602 to get more information about an individual vulnerability. For example, the user has clicked, in step 610, on the vulnerability “Input Source Code Input on Mar. 12, 2024 at 4:23 PM to the AI Algorithm has a Stack Overflow Issue” to get more detail on the code with the stack overflow issue in the detail window 603. The viewed code may be source code (e.g., Java source code), may be machine code, assembly code, and/or the like. The detail window 603 may display fixes and/or updates to fix or replace the stack overflow issue.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-STM processors, other industry-equivalent processors, and may perform computational functions using any known or future-developed standard, instruction set, libraries, and/or architecture.

Any of the steps, functions, and operations discussed herein can be performed continuously and automatically.

However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, sub combinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges or steps are disclosed herein, and without intending to publicly dedicate any patentable subject matter.

What is claimed is:

1. A system comprising:
a microprocessor; and
a computer readable medium, coupled with the microprocessor and comprising microprocessor readable and executable instructions that, when executed by the microprocessor, cause the microprocessor to:
determine, in real-time, that a first software application is one of: running, being loaded, being installed, or has been installed;
in response to determining, in real-time, that the first software application is one of: running, being loaded, being installed, or has been installed, identify one or more software components that are associated with the first software application;
generate current supply chain data, wherein the current supply chain data is associated with the first software application and the identified one or more software components associated with the first software application; and
process the current supply chain data to identify one or more vulnerabilities in the first software application and/or the identified one or more software components associated with the first software application.

2. The system of claim 1, wherein the identified one or more software components associated with the first software application comprises one or more of: an operating system, a hypervisor, a container, a virtual machine, a library, an output application, an Integrated Development Environment (IDE), a compiler, an installer, a loader, a second software application executed by the first software application, and an interpreter.

3. The system of claim 1, wherein the first software application is an Artificial Intelligence (AI) algorithm and wherein the current supply chain data comprises real-time supply chain data that comprises at least one of: AI algorithm input prompt data, real-time output data from the AI algorithm, real-time AI algorithm weight data, and real-time prompt filter data.

4. The system of claim 3, wherein the microprocess readable and executable instructions further cause the microprocessor to:
generate, in real-time, based at least on the real-time supply chain data, a real-time vulnerability score; and
generate, for display in a user interface, the real-time vulnerability score.

5. The system of claim 1, wherein the first software application is an Artificial Intelligence (AI) algorithm and wherein the identified one or more software components associated with the AI algorithm comprises one or more of: an operating system, a hypervisor, a container, a virtual machine, a library, an output application, an Integrated Development Environment (IDE), a compiler, an installer, an interpreter, an input application, an input filter, an AI filter algorithm, a vulnerability filter, a weight changing AI algorithm, weights used by the AI algorithm, a backpropagation AI algorithm, a fine-tuning AI algorithm, a training set filter, an obfuscator, a modification AI algorithm, an initial training set, a fine-tuning training set.

6. The system of claim 5, wherein the identified one or more software components associated with the AI algorithm comprises at least one of: the input application, the input filter, the AI filter algorithm, the vulnerability filter, the weight changing AI algorithm, the weights used by the AI algorithm, the backpropagation AI algorithm, the fine-tuning AI algorithm, the training set filter, the obfuscator, the modification AI algorithm, the initial training set, the fine-tuning training set, a final training set, and a final fine tuning training set.

7. The system of claim 1, wherein the microprocess readable and executable instructions further cause the microprocessor to:
generate, for display, in a user interface, the identified one or more vulnerabilities, in the first software application and/or the identified one or more software components associated with the first software application.

8. The system of claim 7, wherein the identified one or more vulnerabilities in the first software application and/or the identified one or more software components associated with the first software application can be individually selected by a user to view code associated with the identified one or more vulnerabilities, in the first software application and/or the identified one or more software components associated with the first software application.

9. The system of claim 1, wherein generating the current supply chain data comprises getting real-time supply chain data, getting internal non-real-time supply chain data, and getting external non-real-time supply chain data.

10. A method comprising:
determining, by a microprocessor, in real-time, that a first software application is one of: running, being loaded, being installed, or has been installed;
in response to determining, by the microprocessor in real-time, that the first software application is one of: running, being loaded, being installed, or has been installed, identifying, by the microprocessor, one or more software components that are associated with the first software application;
generating, by the microprocessor, current supply chain data, wherein the current supply chain data is associated with the first software application and the identified one or more software components associated with the first software application; and
processing, by the microprocessor, the current supply chain data to identify one or more vulnerabilities in the first software application and/or the identified one or more software components associated with the first software application.

11. The method of claim 10, wherein the identified one or more software components associated with the first software application comprises one or more of: an operating system, a hypervisor, a container, a virtual machine, a library, an output application, an Integrated Development Environment (IDE), a compiler, an installer, a loader, a second software application executed by the first software application, and an interpreter.

12. The method of claim 10, wherein the first software application is an Artificial Intelligence (AI) algorithm and wherein the current supply chain data comprises real-time supply chain data that comprises at least one of: AI algorithm input prompt data, real-time output data from the AI algorithm, real-time AI algorithm weight data, and real-time prompt filter data.

13. The method of claim 12, further comprising:
generating, in real-time, based at least on the real-time supply chain data, a real-time vulnerability score; and
generating, for display, in a user interface, the real-time vulnerability score.

14. The method of claim 10, wherein the first software application is an Artificial Intelligence (AI) algorithm and wherein the identified one or more software components associated with the AI algorithm comprises one or more of: an operating system, a hypervisor, a container, a virtual machine, a library, an output application, an Integrated Development Environment (IDE), a compiler, an installer, an interpreter, an input application, an input filter, an AI filter algorithm, a vulnerability filter, a weight changing AI algorithm, weights used by the AI algorithm, a backpropagation AI algorithm, a fine-tuning AI algorithm, a training set filter, an obfuscator, a modification AI algorithm, an initial training set, a fine-tuning training set.

15. The method of claim 14, wherein the identified one or more software components associated with the AI algorithm comprises at least one of: the input application, the input filter, the AI filter algorithm, the vulnerability filter, the weight changing AI algorithm, the weights used by the AI algorithm, the backpropagation AI algorithm, the fine-tuning AI algorithm, the training set filter, the obfuscator, the modification AI algorithm, the initial training set, the fine-tuning training set, a final training set, and a final fine tuning training set.

16. The method of claim 10, further comprising:
generating, for display, in a user interface, the identified one or more vulnerabilities, in the first software application and/or the identified one or more software components associated with the first software application.

17. The method of claim 16, wherein the identified one or more vulnerabilities, in the first software application and/or the identified one or more software components associated with the first software application can be individually selected by a user to view code associated with the identified one or more vulnerabilities, in the first software application and/or the identified one or more software components associated with the first software application.

18. The method of claim 10, wherein generating the current supply chain data comprises getting real-time supply chain data, getting internal non-real-time supply chain data, and getting external non-real-time supply chain data.

19. A non-transient computer readable medium having stored thereon instructions that cause a processor to execute a method, the method comprising instructions to:
determine, in real-time, that a software application is one of: running, being loaded, being installed, or has been installed;
in response to determining, in real-time, that the software application is one of:
running, being loaded, being installed, or has been installed, identify one or more software components that are associated with the software application;
generate current supply chain data, wherein the current supply chain data is associated with the software application and the identified one or more software components associated with the software application; and
process the current supply chain data to identify one or more vulnerabilities in the software application and/or the identified one or more software components associated with the software application.

20. The non-transient computer readable medium of claim 19, wherein the software application is an Artificial Intelligence (AI) algorithm and wherein the current supply chain data comprises real-time supply chain data that comprises at least one of: AI algorithm input prompt data, real-time output data from the AI algorithm, real-time AI algorithm weight data, and real-time prompt filter data.
